(19) United States
(12) Patent Application Publication
(10) Pub. No.: US 2003/0205122 A1
(43) Pub. Date: Nov. 6, 2003

(54) Punching device for edge decoration

(75) Inventor: Wan-Young Oh, Seoul (KR)

Correspondence Address: STAAS & HALSEY LLP, SUITE 700, 1201 NEW YORK AVENUE, N.W., WASHINGTON, DC, 20005, US

(73) Assignee: DN CRAFT CORPORATION, Seoul (KR)

(21) Appl. No.: 10/151,906

(22) Filed: May 22, 2002

(30) Foreign Application Priority Data
May 3, 2002 (KR) 2002-24514

(51) Int. Cl. B26D 5/08; B26F 1/14

(52) U.S. Cl. 83/687; 83/588; 83/620

(57) ABSTRACT

A punching device for edge decoration, which enables to repeatedly punch a pattern in a target such as paper along edges of the target, includes a jig (15) in which a predetermined pattern (17) is perforated, a punching member (13) having a section corresponding to the perforated pattern (17) and being slidable through the perforated pattern (17), and a base (19) combined with the jig (15) and having an angle (θ) in range of 60°≦θ≦180° to the perforated pattern (17), the base (19) having a standard marking (20) with a pattern corresponding to all or part of the perforated pattern (17).

### BACKGROUND OF THE INVENTION

1. Field of the Invention

The present invention relates to a punching device, and more particularly to a punching device for edge decoration, which enables to repeatedly punch a pattern in a target such as paper along edges of the target.

2. Description of the Related Art

Generally, a punching device, which is also called ‘punch’ in common, includes a jig in which a specific pattern is perforated and a sharp cutting means sliding through the perforated pattern. This punching device performs punching a desired area in a target according to the perforated pattern.

There have been developed various kinds of punching devices. However, these punching devices are not appropriate to perforate a target along its edge accurately because they are mainly purposed to pick out a certain area of the target.

In other words, when punching same pattern successively along an edge of card, letter paper, photograph or other various boards for decoration, a user punches the pattern by only eye measurement, thus resulting in irregular arrangement of punched patterns in the target.

### SUMMARY OF THE INVENTION

The present invention is designed to overcome such disadvantages of the prior art, and an object of the invention is to provide a punching device, which enables to accurately punch same pattern successively along an edge of a target.

In order to accomplish the above object, the present invention provides a punching device for edge decoration, which includes a jig in which a predetermined pattern is perforated, a punching member having a section corresponding to the perforated pattern and being slidable through the perforated pattern, and a base combined with the jig and having an angle (θ) in range of 60°≦θ≦180° to the perforated pattern, the base also having a standard marking with a pattern corresponding to all or part of the perforated pattern.

Preferably, the angle (θ) is determined to be an interior angle of a closed polygon having a circumference corresponding to integer times of a length of the perforated pattern.

The jig may includes an upper plate having a guide perforation to guide sliding movement of the punching member, and a lower plate installed to the upper plate with a predetermined gap for insertion of a target for punching, in which the pattern is perforated into the lower plate at a position corresponding to the guide perforation.

The base may further have a guide protrusion to guide an outer circumference of a circular target for punching.

In another aspect of the present invention, there is provided a punching device for punching edge of a rectangular target into a shape of closed polygon, which includes a jig in which a predetermined pattern is perforated, a punching member having a section corresponding to the perforated pattern and being slidable through the perforated pattern, and a base combined with the jig and having a horizontal guide at a rear position of the pattern to fit a side of the rectangular target thereto and an inclined guide having an angle of 45° with the horizontal guide so that the rectangular target is fit thereto with being turned 45°.

The punching device of the present invention may further include a guide member positioned at the rear of the perforated pattern, in which the guide member has two sides at a right angle to restrict insertion of the target to a predetermined level.

Preferably, an additional standard marking is formed on the base at one or both sides of the perforated pattern in parallel to the pattern, and the additional standard marking has a pattern corresponding to all or part of the perforated pattern.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a perspective view showing a punching device according to a preferred embodiment of the present invention;

FIG. 2 is an exploded view of FIG. 1;

FIG. 3 is a perspective showing a punching member shown in FIG. 2;

FIG. 4 shows a target that is punched in a straight line by the punching device of the present invention;

FIG. 5 shows a target that is punched in a garden type by the punching device of the present invention;

FIG. 6 is a diagram showing the radius of curvature of a circular target and the radius of curvature of a punching pattern;

FIG. 7 schematically shows a standard marking formed at an angle with a perforated pattern according to the present invention;

FIG. 8 schematically shows a standard marking formed at a smaller angle with the perforated pattern than the case of FIG. 7;

FIG. 9 schematically shows a standard marking formed at an angle of 60° with the perforated pattern;

FIG. 10a is a schematic diagram showing a centerline of an arc pattern;

FIG. 10b is a schematic diagram showing a centerline of a straight pattern;

FIG. 11 exemplarily shows an angle between centerlines of two art patterns;

FIG. 12 is a schematic diagram showing that there are formed a plurality of standard markings at different angles to a perforated pattern;

FIG. 13 is a schematic diagram showing that there are formed two standard markings at different angles to a perforated pattern;

FIG. 14 shows a circular target, which is punched one time by the punching device of the present invention;

FIG. 15 shows the circular target of FIG. 14, which is punched once more conforming to the previously punched area;

FIG. 16 shows the circular target, which is punched repeatedly in the same manner as FIG. 15;

FIG. 17 shows a punched state in an oval shape by using the punching device of the present invention;

FIG. 18 shows a horizontal guide and an inclined guide formed on a base of the punching device according to another embodiment of the present invention;

FIG. 19 is a schematic diagram showing an example of a guide member according to the present invention;

FIG. 20 is a schematic diagram showing another example of the guide member according to the present invention;

FIG. 21 shows a rectangular target, which is punched with a side of the target being fit with the horizontal guide; and

FIG. 22 shows the rectangular target of FIG. 21, which is punched once more after the target is turned 45° to be fit with the inclined guide.

### DETAILED DESCRIPTION OF THE PREFERRED EMBODIMENT

Hereinafter, preferred embodiments of the present invention will be described in detail with reference to the accompanying drawings.

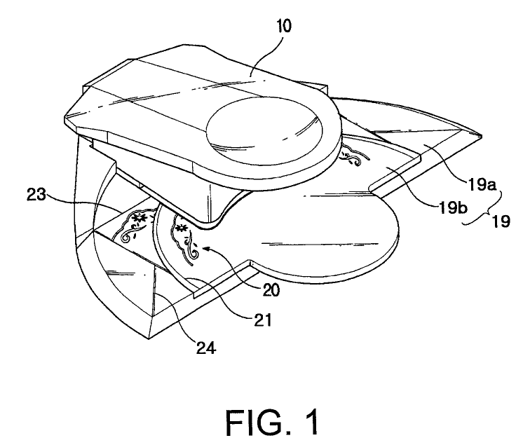

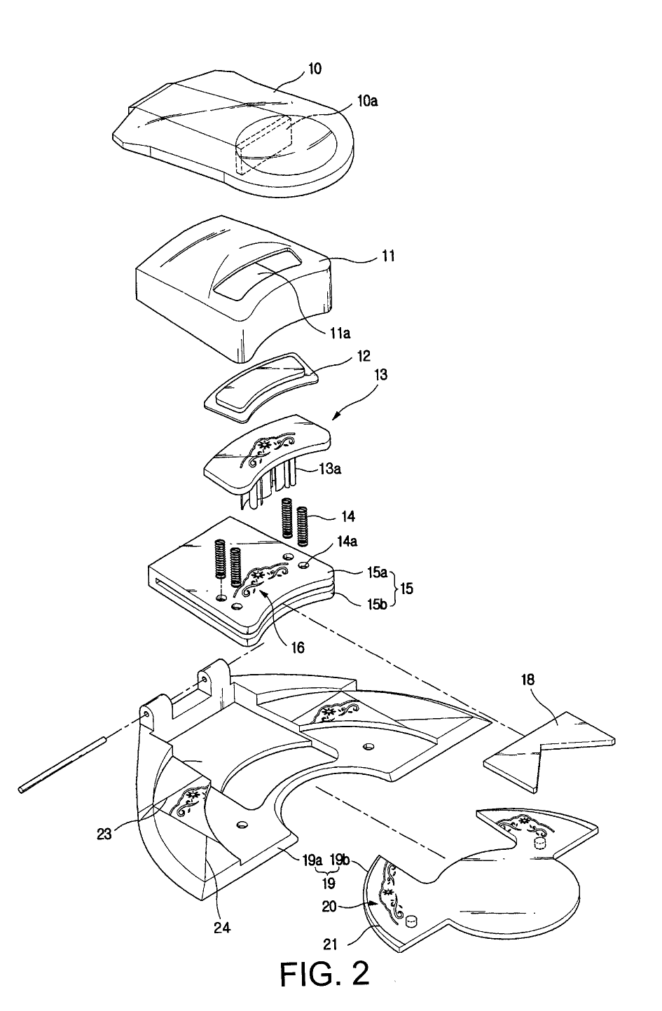

FIG. 1 is a perspective view showing a punching device according to a preferred embodiment of the present invention and FIG. 2 is an exploded view showing the punching device in detail. Referring to FIGS. 1 and 2, the punching device of the present invention broadly includes a pressing lever 10, a punching member 13, a jig 15 and a base 19.

The pressing lever 10 is pivotally connected to the base 19 so that the lever 10 presses the punching member 13 downward when pushed down by the hand of a user.

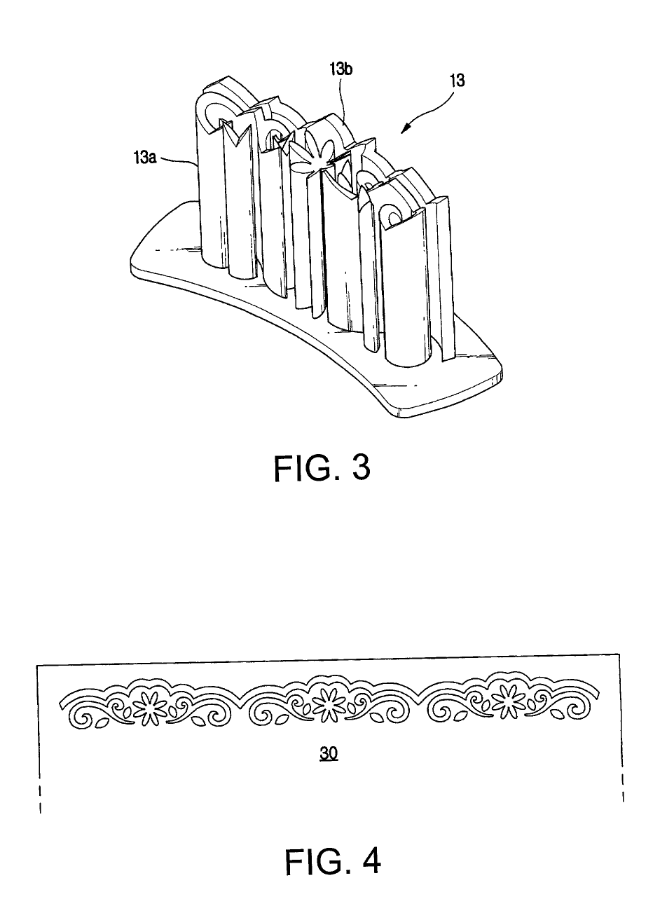

The punching member 13 plays a role of punching a pattern in a target. For that purpose, a punch pin 13a having a corresponding pattern is formed at a lower portion of the punching member 13. At a lower edge of the punch pin 13a, formed is a cutting blade (not shown) to easily and clearly punch the pattern in the target. Preferably, the punching member 13 has a rim cutting pin 13b, as shown in FIG. 3, in order to cut off a necessary margin out of the pattern when punching.

The jig 15 supports a supplied target during punching. This jig 15 preferably includes upper and lower plates 15a, 15b, facing each other with a space into which a target to be punched can be inserted.

In the lower plate 15b, a pattern corresponding to the punch pin 13a is perforated. In the upper plate 15a, a guide hole 16 is formed to guide vertical movement of the punch pin 13a. Alternatively, it is also possible to configure the jig 15 integrally, not separating upper and lower plates 15a, 15b. In this configuration, the jig may include a plate (not shown) in which a pattern is perforated and a guide (not shown) for pressing and guiding a target supplied to an upper or lower surface of the plate.

An elastic member 14 is interposed between the punching member 13 and the jig 15 for elastically biasing the punching member 13 against the jig 15. Thus, after descending to punch a pattern in a target supplied to the jig 15, the punching member 13 returns its initial position owing to elasticity of the elastic member 14.

For that reason, a spring is adopted for the elastic member 14 in which one end is combined to a side of the upper plate 15a through a support 14a and the other end is combined to the punching member 13 to provide elastic force. As for the elastic member 14, leaf spring or other means can be adopted.

Though shown in the figure that the support 14a has a groove shape so that a lower end of the elastic member 14 seats thereon, the support 14a may have another configuration such as a protrusion so that the support 14a is inserted to a lower end of the elastic member 14.

Preferably, the punching member 13 is stably combined to the jig 15 in a housing 11. At an upper surface of the housing 11, a hole 11a is formed so that the press pin 10a at the pressing lever 10 may press an upper surface of the punching member 13 through the hole 11a.

More preferably, a cap member 12 may be further provided between the pressing lever 10 and the punching member 13 so as to prevent them from being directly contacted, for the purpose of smooth operation. This cap member 12 contacts with a broad area of the upper surface of the punching member 13, thus disperses pressure evenly to overall upper surface of the punching member 13 though a tip of the pressing pin 10a has a small area contacted with the cap member 12.

The base 19 configures a foundation of the device. This base 19 supports the above-described parts and acts as a basis on which a target is supplied for formation of pattern. The pressing lever 10 is hinged to the base 19.

The base 19 may be a unitary body or be configured to have a first base 19a and a second base 19b detachably combined to the first base 19a, as shown in the figures.

According to the present invention, there may be provided a means for guiding a target to a circular or rectangular direction so as to substantially punch patterns in the target in a circular or rectangular shape. Such guide means includes a standard marking 20 printed or marked on the surface of the base 19 and a guide protrusion 21, which is preferably formed in an arc shape on the base 19.

The standard marking 20 has a pattern corresponding to all or part of the section shape of the punch pin 13a. This standard marking 20 helps to move a target to a desired distance or angle so that a user may accurately and conveniently punch successive patterns in the target with moving or rotating the target. The shape of the standard marking 20 determines arrangement of successive patterns: whether to adjust the target to a straight direction or a circumferential direction, or whether to adjust the target to a circumferential direction of a small or big radius. For example, in case of punching successive patterns in a target with a standard marking 20, which is in parallel to the perforated pattern, the punched patterns become straightly arranged as shown in FIG. 4.

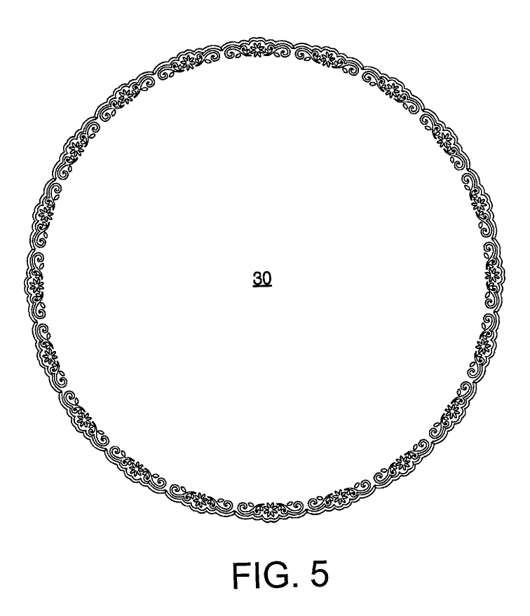

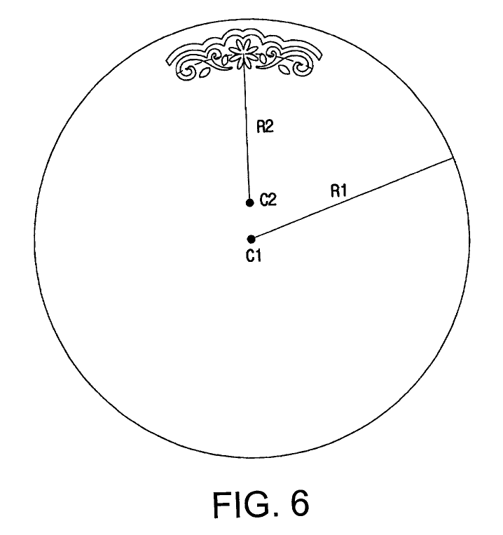

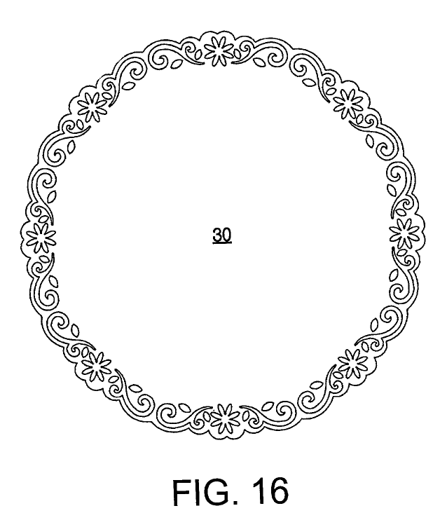

On the other hand, in case of punching successive patterns in a target with a standard marking 20, which is inclined to the perforated pattern, the target would obtain punched patterns in circular or polygonal arrangement, as shown in FIGS. 5 and 16. In this case, a circular target 30 is preferably used, as shown in FIG. 6.

At this time, if a center C1 of the target 30 with the radius of curvature R1 is coinciding with a center C2 of the punched patterns with the radius of curvature R2, the punched patterns would be arranged in an accurate circle, as shown in FIG. 5.

On the other hand, of the center C1 of the target 30 is not coinciding with the center C2 of the punched patterns, the patterns would be punched in so-called flower arrangement due to an angle between each pattern in an arc.

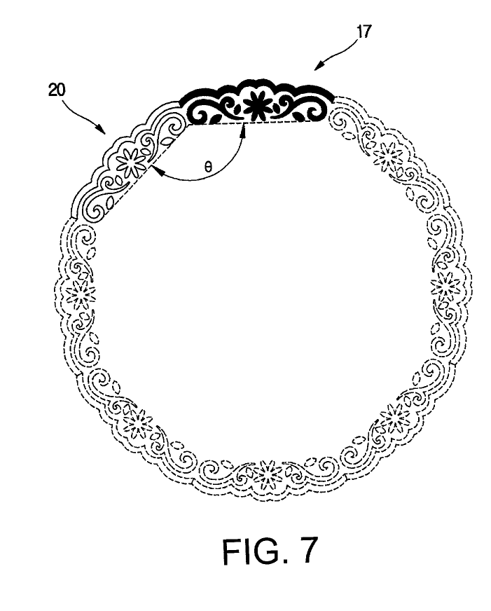

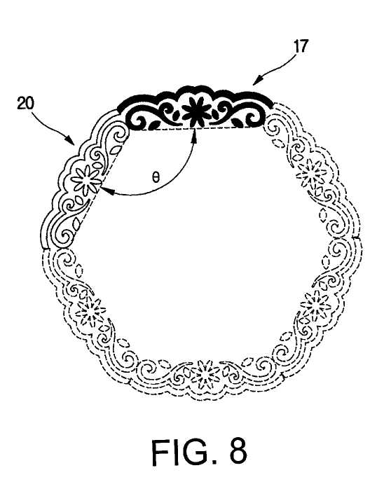

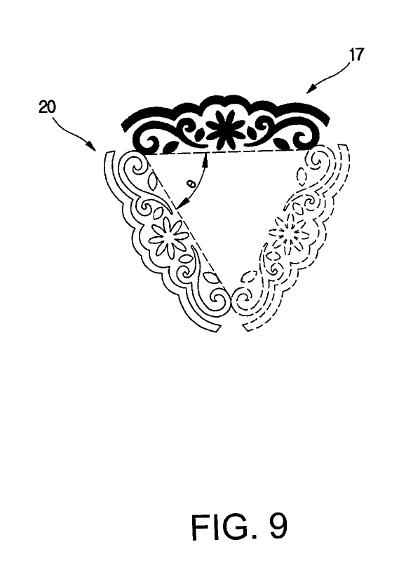

If the pattern has a straight shape, not an arc shape, there is created an angle θ between the standard marking 20 and the perforated pattern 17. Thus, if punching the straight pattern successively in a target, the punched patterns would be arranged in an equilateral polygon, which has an interior angle θ. If the standard marking 20 were formed to have the angle θ decreased, the number of sides of the polygon would be reduced, like FIG. 8. At this time, a minimum value of the angle θ is 60°, which makes the punched patterns in a regular triangle, as shown in FIG. 9. In FIGS. 7 to 9, dotted patterns schematically show patterns, which would be obtained when punching the pattern after turning the target in a circumferential direction.

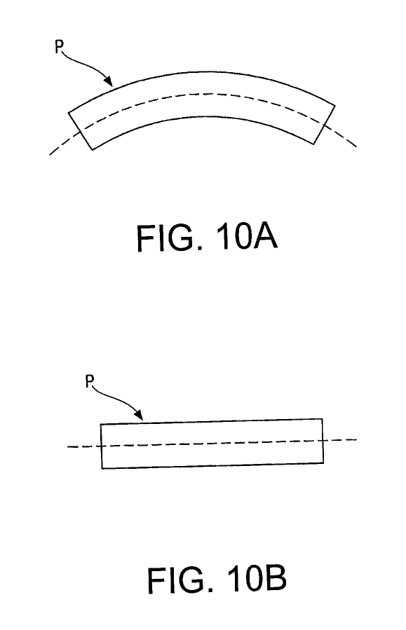

In this embodiment, the angle θ is defined as an angle between virtual lines of patterns, which respectively represent formation of the patterns. In FIGS. 7 to 9, a lower side of the pattern is set as the virtual line. But, not limited to that case, the virtual line can be set as a centerline of the pattern (P) as shown with dotted lines in FIGS. 10a and 10b. In addition, the virtual line can be a straight line or an arc depending on the pattern (P).

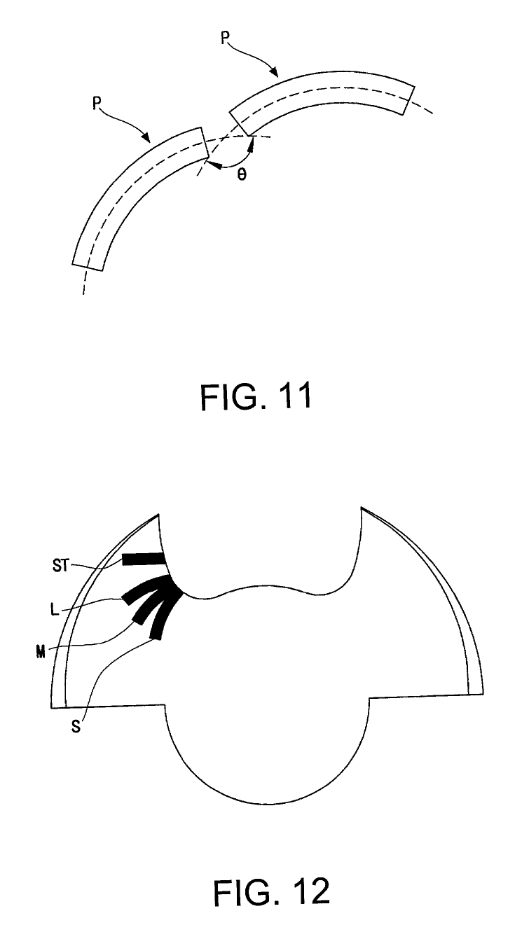

FIG. 11 schematically shows that arc virtual lines of two patterns are crossed at the angle θ. At this time, a maximum value of the angle θ is 180° when centers C1, C2 of the arc-type patterns are coincided as shown in FIG. 6, while a minimum value of the angle θ is 60° as described above.

As would be understood in the above description, the standard marking 20 is a basis of determining the angle θ between a punched pattern and a pattern to be successively punched in the target. Thus, the punching device of the present invention may obtain pattern arrangement in a target from a rectangular to a circle and the angle θ varies in a range of 60°≦θ≦180°.

In this document, inventors define all figures such as circle, equilateral polygon and flower shape as ‘closed polygon’. Though not scientific or lexicological, this term should be interpreted as defined above, not to be considered as indefinite, because it is defined as the inventors intended, on grounds of the principle that an inventor may define terms appropriately to express the best mode of his/her own invention.

In the present invention, it should be noted that the angle θ between patterns is preferably defined discontinuously. In other words, the angle θ should be preferably determined on consideration of the length of the pattern. More specifically, the angle θ is defined so that the integer-number of punched patterns should form an accurate closed polygon.

For example, in case of an equilateral polygon, the angle θ is determined with the following equation:

$$θ = 180 - \frac{360}{n} \qquad equation ( 1 )$$

where, n is the number of punched patterns.

As described above, since a size of the closed polygon can be adjusted depending on a position of the standard marking 20, it is preferred to form a plurality of standard markings at different angles to the perforated pattern 17 on the base 19 so that a user may select a size of the closed polygon with the standard markings.

The standard markings described as above are schematically shown in FIG. 12 as a dark pattern. Referring to FIG. 12, a standard marking ST is used to punch patterns in a straight line, while standard markings L, M and S are respectively used to punch patterns into a large, medium or small size.

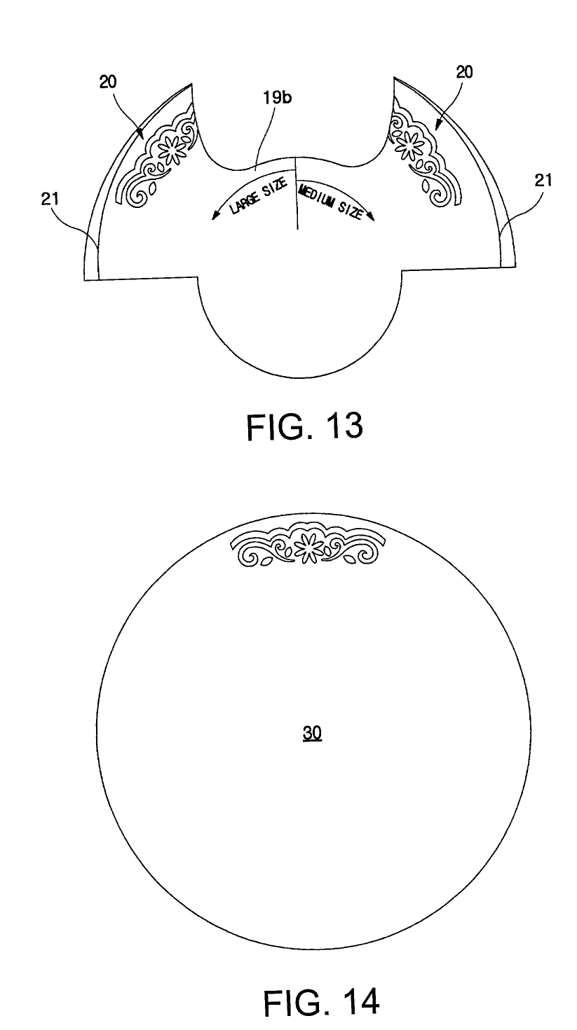

FIG. 13 shows another example providing several standard markings. In FIG. 13, two standard markings at different angles to the perforated pattern 17 are respectively formed at both sides on the second base 19b. In this case, the patterns are punched in a relatively small size with turning a target clockwise, rather than the opposite case.

Preferably, the guide protrusion 21 is additionally formed on the second base 19b in an arc shape so that an outer circumference of a circular target may be fit thereto.

Now, a method of using the punching device of the present invention is described.

First, a target 30 with preferably a circular shape is inserted between the upper and lower plates 15a, 15b of the jig 15. If a user pushes down the pressing lever 10, a pattern is punched in the target 30 as shown in FIG. 14.

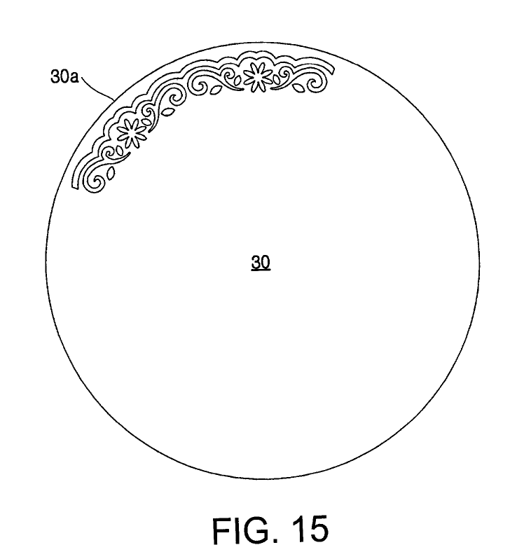

Then, the target 30 is turned so that the punched pattern coincides with the standard marking 20. If a user pushes down the pressing lever 10 again in this state, another pattern is punched in the target 30 nearby the previously punched pattern, as shown in FIG. 15. At this time, since the rim cutting pin 13b is preferably configured in the punching member 13, a margin 30a is separated from the punched pattern.

By punching the pattern repeatedly as described above, the margin 30a are fallen apart and the closed polygon shown in FIG. 16 is obtained.

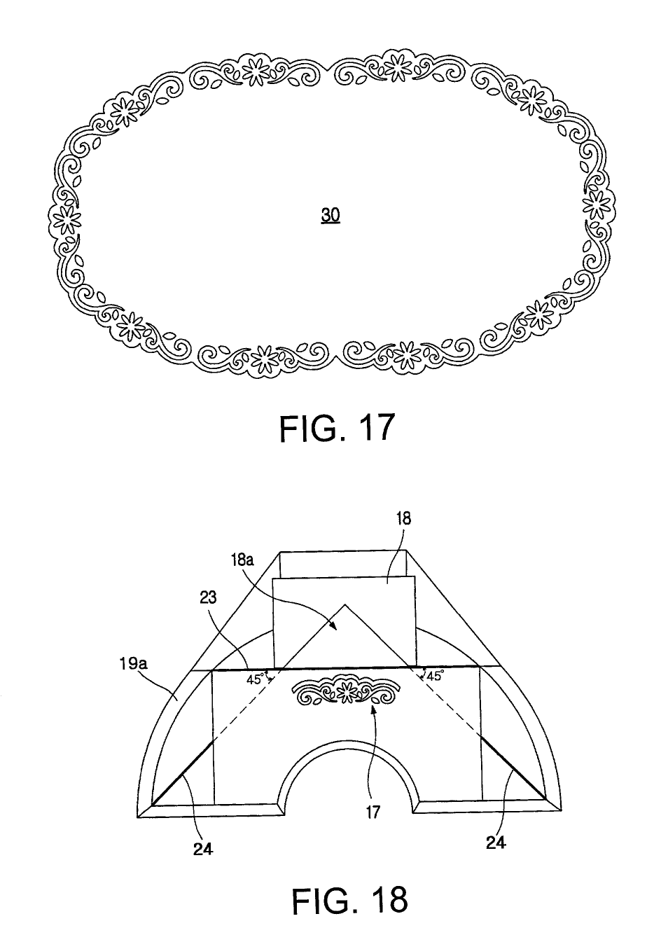

As an alternative, it is also possible to punch patterns in an oval-like shape as shown in FIG. 17 by using an arc standard marking and a straight standard marking together.

According to another embodiment of the present invention, there is provided a punching device, which includes a horizontal guide 23 and an inclined guide 24 on the first base 19a, as shown in FIG. 18. This punching device enables to punch patterns in a rectangular target.

In more detail, the horizontal guide 23 is formed at the rear of the perforated pattern 17 so that a side of the rectangular target may be fit thereto, while the inclined guide 24 is formed at an angle of 45° to the horizontal guide 23 so that the side of the rectangular target is fit thereto after being turned 45° clockwise or counterclockwise.

The horizontal guide 23 and the inclined guide 24 may be formed by printing a line or providing a protrusion or a groove along the line on the first base 19a.

Additionally, a guide member 18 may be preferably provided at the rear of the perforated pattern 17 so as to restrict an insertion depth of a rectangular target, which inserted between the upper and lower plates 15a, 15b of the jig 15.

At this time, the guide member 18 preferably has a rectangular groove 18a with two members at a right angle so as to support the rectangular target, which is inserted between the upper and lower plates 15a, 15b with being fit to the inclined guide 24. In this case, a rectangular corner of the target inserted between the upper and lower plates 15a, 15b is supported by the rectangular groove 18a of the guide member 18.

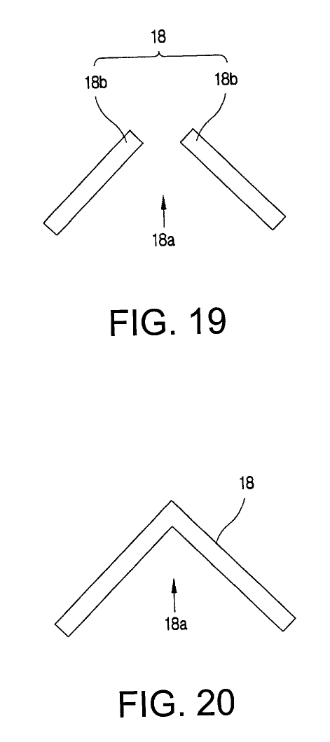

The guide member 18 can be a unitary body or have two guide bars 18b positioned at a right angle to form the rectangular groove 18a as shown in FIG. 19. Or else, two guide bars 18b can be linked each other to form the rectangular groove 18a as shown in FIG. 20.

Now, a method of using the punching device according this embodiment is described.

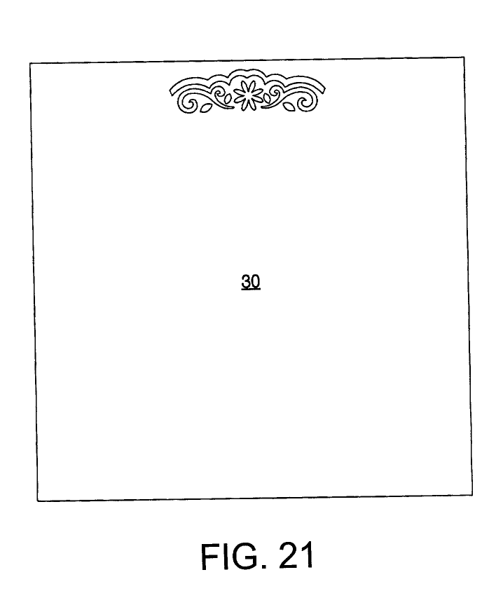

First, a target 30 with preferably a rectangular shape is inserted between the upper and lower plates 15a, 15b of the jig 15. If a user pushes down the pressing lever 10, a pattern is punched in the target 30 as shown in FIG. 21.

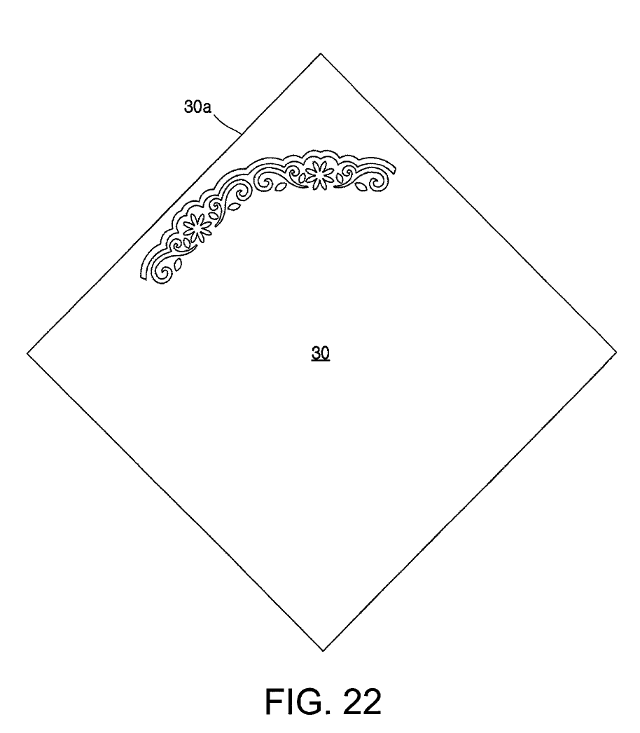

After turning the target 30 at 45° counterclockwise, a user inserts the target 30 between the upper and lower plates 15a, 15b of the jig 15 so that a rectangular corner of the target 30 may be supported by the rectangular groove 18a. Then, if the user fits a side of the target 30 to the inclined guide 24 and then pushes down the pressing lever 10, a pattern is additionally punched in the rectangular target 30 as shown in FIG. 22.

By punching the pattern repeatedly as described above, the margin 30a are fallen apart from the target 30 and the closed polygon shown in FIG. 16 is obtained.

As described above, the punching device of the present invention enables to obtain various pattern arrangements such as circle, equilateral polygon or flower shape by punching a specific pattern successively in a target. Therefore, the present invention gives an effect of punching an exquisite pattern along an edge of an object such as card, letter paper, photograph or other boards, which need edge decoration.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A punching device for edge decoration comprising:
a jig (15) in which a predetermined pattern (17) is perforated;
a punching member (13) having a section corresponding to the perforated pattern (17), the punching member (13) being slidable through the perforated pattern (17); and
a base (19) combined with the jig (15) and having an angle (θ) in range of 60°≦θ≦180° to the perforated pattern (17), the base (19) having a standard marking (20) with a pattern corresponding to all or part of the perforated pattern (17).

2. A punching device according to claim 1,
wherein the angle (θ) is determined to be an interior angle of a closed polygon having a circumference corresponding to integer times of a length of the perforated pattern (17).

3. A punching device according to claim 1, wherein the jig (15) includes:
an upper plate (15a) having a guide hole (16) to guide sliding movement of the punching member (13); and
a lower plate (15b) installed to the upper plate (15a) with a predetermined gap for insertion of a target for punching,
wherein the pattern (17) is perforated into the lower plate (15b) at a position corresponding to the guide hole (16).

4. A punching device according to claim 2, wherein the jig (15) includes:
an upper plate (15a) having a guide hole (16) to guide sliding movement of the punching member (13); and
a lower plate (15b) installed to the upper plate (15a) with a predetermined gap for insertion of a target for punching,
wherein the pattern (17) is perforated into the lower plate (15b) at a position corresponding to the guide hole (16).

5. A punching device according to claim 1,
wherein the base (19) further has a guide protrusion (21) to guide an outer circumference of a circular target for punching.

6. A punching device according to claim 2,
wherein the base (19) further has a guide protrusion (21) to guide an outer circumference of a circular target for punching.

7. A punching device according to claim 1,
wherein an additional standard marking is formed on the base (19) at one or both sides of the perforated pattern (17) in parallel to the pattern (17), and the additional standard marking has a pattern corresponding to all or part of the perforated pattern (17).

8. A punching device for punching edge of a rectangular target into a shape of closed polygon, comprising:
a jig (15) in which a predetermined pattern (17) is perforated;
a punching member (13) having a section corresponding to the perforated pattern (17), the punching member (13) being slidable through the perforated pattern (17); and
a base (19) combined with the jig (15), the base (19) having a horizontal guide (23) at the rear position of the pattern (17) to fit a side of the rectangular target thereto and an inclined guide (24) having an angle of 45° with the horizontal guide (23) so that the rectangular target is fit thereto with being turned 45°.

9. A punching device according to claim 8, further comprising a guide member (18) to be positioned at the rear of the pattern (17), the guide member (18) having two sides at a right angle to restrict insertion of the target to a predetermined level.

10. A punching device according to claim 8,
wherein an additional standard marking is formed on the base (19) at one or both sides of the perforated pattern (17) in parallel to the pattern (17), and the additional standard marking has a pattern corresponding to all or part of the perforated pattern (17).
